(19) United States
(12) Patent Application Publication
(10) Pub. No.: US 2005/0285301 A1
(43) Pub. Date: Dec. 29, 2005

(54) Method of making a detailed replica

(76) Inventors: David Walter Claus, Portland, OR (US); Joseph Hanson, Portland, OR (US)

Correspondence Address: Dr. David Claus;c/o Empire Laboratories, Inc, PO Box 3062, Portland, OR, 97208, US

(21) Appl. No.: 10/880,832

(22) Filed: Jun. 29, 2004

(51) Int. Cl. B29C 33/40

(52) U.S. Cl. 264/222

(57) ABSTRACT

An economical method of facilitating the molding and casting of a mans penis, which may be completed at a mobile location, including the steps of inserting the penis into a molding container which is filled with a solidifying molding material, withdrawing the penis, thereby creating a negative impression of it, placing a two to five inch phallic shaped vibrating device into the negative impression in order to partially fill the area, and filling the remaining negative impression area with a pour able polyurethane or silicone material capable of curing into a flexible form within the molding material and around the vibrating device, thereby revealing a functional, vibrating replica of the original penis. Using a phallic shaped vibrating device to displace the expensive casting material is what makes this process so economical. The vibrating device placed into the mold results in the need for far less casting material than would be necessary without inserting the vibrating device. The casting material is typically the most expensive component of the molding and casting process. This method would be incorporated into directions within a kit containing all major necessary materials to produce the replica.

### REFERENCES CITED

### U.S. Patent Documents

U.S. Pat. No. 3,601,177 August 1971 Hall . . . 264/222

U.S. Pat. No. 4,015,327 April 1977 McCarthy . . . 264/222

U.S. Pat. No. 4,086,666 May 1978 Vasky et al . . . 264/222

U.S. Pat. No. 4,260,574 April 1981 Macomson . . . 264/129

U.S. Pat. No. 4,335,067 June 1982 Castanis et al . . . 264/222

DE 3,601,36 July 1987 Strietner . . . GERMANY

U.S. Pat. No. 4,828,116 May 1989 Garcia . . . 206/223

U.S. Pat. No. 5,234,976 August 1993 Prent . . . 524/028

U.S. Pat. No. 5,798,062 August 1998 Theilbar . . . 264/155

### BACKGROUND OF THE INVENTION

The present invention relates to a method of making a detailed replica of a man's penis into a vibrating copy, of the type that may be used as a personal dildo. Although the replicating of body parts through the use of various mold processes has long been known, it is believed that the particular process described herein for making a replica of a penis is new.

Based on a long felt need in the industry to cut costs by using less of the expensive casting materials necessary to produce a quality, flexible replica, placing a two to five inch phallic shaped vibrating device into the mold before filling it with a polyurethane or silicone will displace much of the area to fill, resulting in the need for far less of the costly casting material.

U.S. Pat. Nos. 4,086,666, 3,601,177, 4,015,327, 4,260,574, 5,234,976, 4,335,067, 4,828,116, 5,798,062 are representative of previous patents granted for replica making processes which utilize an elastic impression forming material such as an alginate, and filling that impression with various solidifying materials. However, a method is not believed to be previously known in which an accurate, permanent, flexible, vibrating replica of a human penis can be quickly, easily and inexpensively produced.

### BRIEF DESCRIPTION OF THE DRAWINGS

FIG. 1 is a perspective view showing a man's penis.

FIG. 2 is a perspective view of the penis-casting container being filled with a curable, formable molding material such as an alginate and water mixture.

FIG. 3 is a perspective view of a man's penis being inserted into the filled molding container.

FIG. 4 is a perspective view of the finished penis mold.

FIG. 5 is a perspective view of a phallic shaped vibrating device being placed into the mold.

FIG. 6 is a perspective view of the mold being filled with a flexible, solidifying casting material such as a polyurethane or silicone resin.

FIG. 7 is a perspective view of the finished cast containing the vibrating device.

### DESCRIPTION OF THE PREFERRED EMBODIMENT

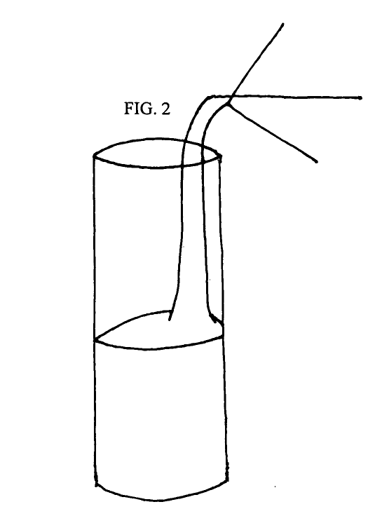

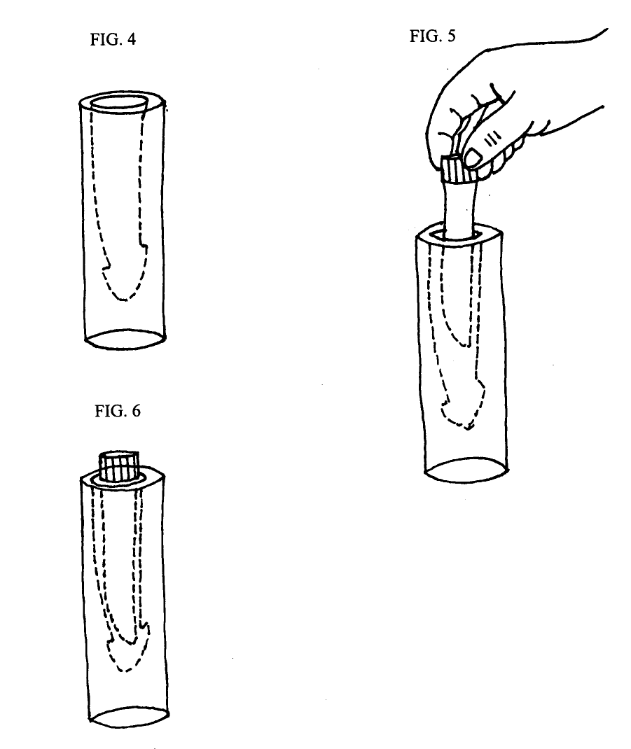

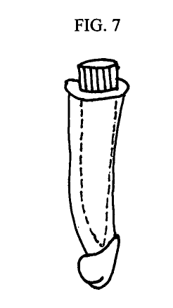

Referring more specifically to the drawings, in FIG. 1 a man's erect penis is shown. It may be erect or flaccid, as the method will work either way. FIG. 2 shows a cylindrical molding container being filled with an impression forming material such as an alginate and water mixture. The molding container may be of any suitable material such as plastic, acrylic, butyrate, Styrofoam, paper or other material capable of containing the impression forming material. The container is shaped cylindrically and sized to accommodate the majority of men's penises. FIG. 3 shows the penis being inserted into the filled molding container, where it will remain until the material sets. FIG. 4 shows the finished, detailed mold. In FIG. 5 a vibrating device is being inserted into the mold to partially fill the area. FIG. 6 shows the remainder of the area being filled with a pour able, formable, solidifying material. A silicone or polyurethane resin is ideally suited as a casting agent, as either will cure within a water based alginate mold, a plaster mold, or a silicone mold, and their pliant properties are ideally suited for use as a dildo. After an appropriate cure time, the finished cast is withdrawn from the mold. FIG. 7 shows the finished, flexible cast made from the original penis, and the vibrating device within.

Thus the present invention provides a simple, safe, and very economical method of producing a detailed, vibrating copy of an actual penis. This method can be easily incorporated into directions in a penis molding and casting kit.

In the drawings and specification, there has been set forth a preferred embodiment of the invention and, although specific terms are employed, they are used in a generic and descriptive sense only and are not for purposes of limitation, the scope of the invention being described in the claim.

1. A method of making an inexpensive, detailed replica of an actual penis by using a specifically designed cylindrical molding container filled with a formable and curable molding material to produce the mold, placing a phallic shaped vibrating device into that mold to partially fill the area, then filling the remainder of the mold with a pour able, curable casting material to create the finished copy.
